(19) United States
(12) Patent Application Publication
(10) Pub. No.: US 2026/0086661 A1
(43) Pub. Date: Mar. 26, 2026

(54) MANIPULATING DEVICE

(71) Applicant: Sony Interactive Entertainment Inc., Tokyo (JP)

(72) Inventors: Hideki MORI, Tokyo (JP); Yuta KODA, Kanagawa (JP); Yoshihisa TAKAHASHI, Saitama (JP); Koichi SHIONO, Kanagawa (JP)

(73) Assignee: Sony Interactive Entertainment Inc., Tokyo (JP)

(21) Appl. No.: 19/111,326

(22) PCT Filed: Sep. 15, 2022
(86) PCT No.: PCT/JP2022/034561

§ 371 Date: Mar. 13, 2025

(51) Int. Cl. G06F 3/0354; A63F 13/24

(52) U.S. Cl. CPC G06F 3/03548; A63F 13/24

(57) ABSTRACT

There is provided a manipulating device that is capable of expressing pseudo-weights. The manipulating device includes a plurality of link shafts, a plurality of node mechanisms that cooperate with the plurality of link shafts in providing a grid shape, the plurality of node mechanisms holding ends of at least two or more of the link shafts of the plurality of link shafts such that the at least two of the link shafts are variable in posture, a rest base on which the plurality of node mechanisms are placed, and a pulling mechanism for pulling each of the node mechanisms in a direction to return to a predetermined reference position on the rest base.

### TECHNICAL FIELD

The present invention relates to a manipulating device.

### BACKGROUND ART

PTL 1 referred to below discloses a manipulating device for use in manipulating a gaming apparatus. The manipulating device includes manipulating members such as manipulating buttons, direction keys, and a manipulating stick.

### CITATION LIST

### Patent Literature

### [PTL 1]

PCT Patent Publication No. WO2014/061362

### SUMMARY

### Technical Problems

In recent years, gaming apparatuses and the like have become able to express a variety of motions of display objects along with increases in the processing capability of computers. In order to enable such display objects to move in response to manipulations made by a user, there have been demands for manipulating devices that have a high degree of freedom for manipulation. Further, it is preferable for manipulating devices with a high degree of freedom for manipulation to allow the user to have experiences with a feeling of presence based on perception of the user.

The present invention has been made in view of the above problems. It is an object of the present invention to provide a manipulating device that is capable of expressing a pseudo-weight.

In order to meet the above problems, a manipulating device according to the present disclosure refers to a manipulating device for outputting signals to a computer, depending on its posture changes caused by manipulations made by a user. The manipulating device includes a plurality of link shafts, a plurality of node mechanisms that cooperate with the plurality of link shafts in providing a grid shape, the plurality of node mechanisms holding ends of at least two or more of the link shafts of the plurality of link shafts such that the at least two or more of the link shafts are variable in posture, a rest base on which the plurality of node mechanisms are placed, and a pulling mechanism for pulling each of the node mechanisms in a direction to return to a predetermined reference position on the rest base.

### BRIEF DESCRIPTION OF DRAWINGS

FIG. 1 is a diagram illustrating an example of a physical configuration of a display control system according to an embodiment of the present invention.

FIG. 2 is a perspective view illustrating a manipulating device according to the present embodiment.

FIG. 3 is a functional block diagram illustrating an example of functions performed by an information processing apparatus according to the present embodiment.

FIG. 4 is a perspective view illustrating a single node mechanism and four link shafts held by the node mechanism.

FIG. 5 is a perspective view illustrating the node mechanism with an outer covering removed therefrom.

FIG. 6 is an exploded perspective view illustrating the node mechanism with a link shaft removed therefrom.

FIG. 7 is a cross-sectional view illustrating a manner in which a magnet disposed in facing relation to a three-dimensional magnetic sensor is displaced.

FIG. 8 is a view schematically illustrating a wiring arrangement of the display control system according to the present embodiment.

FIG. 9 is a view illustrating positional coordinates of various portions of node mechanisms.

FIG. 10 is a view schematically illustrating a pulling mechanism and members disposed in its periphery according to the present embodiment.

FIG. 11 is a view illustrating a manner in which a node mechanism illustrated in FIG. 10 is displaced upwardly.

FIG. 12 is a view illustrating a manner in which an electric motor of the pulling mechanism is driven by further displacing the node mechanism illustrated in FIG. 11 upwardly.

FIG. 13 is a view illustrating a manner in which node mechanisms are displaced in an X-axis direction according to the present embodiment.

FIG. 14 is a view schematically illustrating a rest base and members disposed in its periphery according to a first modification of the present embodiment.

FIG. 15 is a perspective view schematically illustrating a pulling mechanism according to a second modification of the present embodiment.

### DESCRIPTION OF EMBODIMENT

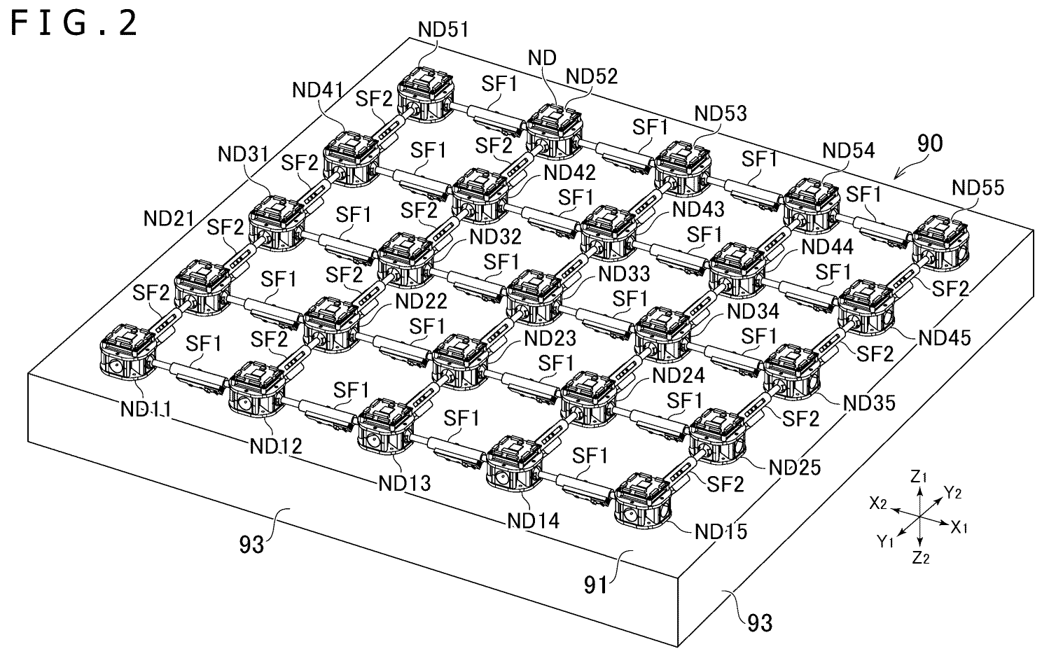

An embodiment of the present invention (hereinafter referred to as the “present embodiment”) will be described hereinbelow with reference to the drawings. In the description that follows, directions indicated by arrows X1 and X2 in FIG. 2 and others represent rightward and leftward directions, respectively, directions indicated by arrows Y1 and Y2 in FIG. 2 and others represent forward and rearward directions, respectively, and directions indicated by arrows Z1 and Z2 in FIG. 2 and others represent upward and downward directions, respectively.

### [Outline of Display Control System]

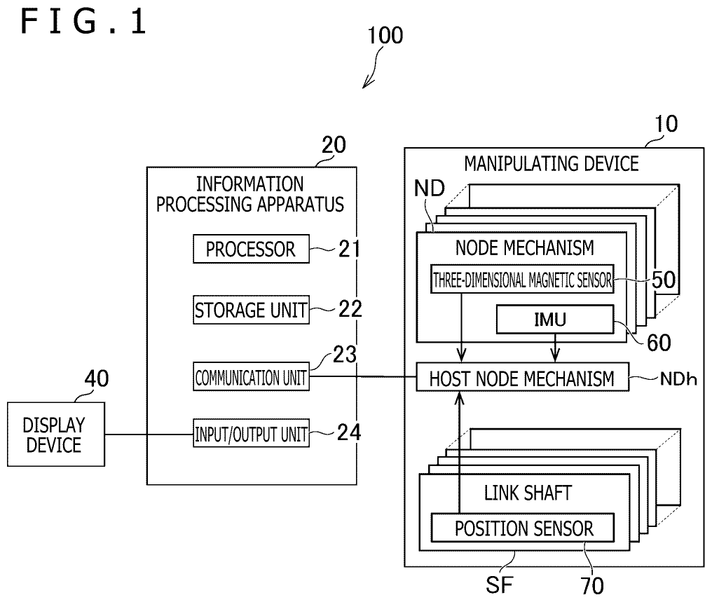

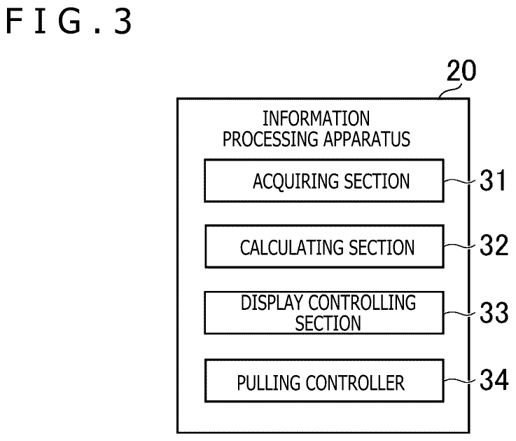

First, an outline of a display control system 100 according to the present embodiment will be described below with reference to FIGS. 1 through 3. FIG. 1 is a diagram illustrating an example of a physical configuration of the display control system according to the present embodiment. FIG. 2 is a perspective view illustrating a manipulating device according to the present embodiment. FIG. 3 is a functional block diagram illustrating an example of functions performed by an information processing apparatus according to the present embodiment.

The display control system 100 includes the manipulating device, denoted by 10, the information processing apparatus (computer), denoted by 20, and a display device 40.

As illustrated in FIG. 2, the manipulating device 10 refers to a grid-shaped device having a plurality of node mechanisms ND and a plurality of link shafts SF. The manipulating device 10 outputs signals to the information processing apparatus 20, depending on its posture changes caused by manipulations made by a user. Note that the manipulating device 10 is preferably of such a size that opposite ends thereof can be gripped by the user with his/her both hands.

As illustrated in FIG. 1, the manipulating device 10 has three-dimensional magnetic sensors 50, inertial measurement units (IMUs) 60, and position sensors 70. In the display control system 100, these various sensors acquire positional coordinates of the respective node mechanisms ND, allowing the overall shape of the manipulating device 10 to be recognized. Note that details of the configurations and functions of the various sensors and the entire configuration of the manipulating device 10 will be described later. Note that, as described later, one node mechanism ND includes four three-dimensional magnetic sensors 50. However, in order to avoid the complexity of illustration in FIG. 1, only one three-dimensional magnetic sensor 50 is illustrated in association with one node mechanism ND.

The information processing apparatus 20 is, for example, preferably a gaming apparatus having a function to execute game programs, a function to reproduce moving images, and a function to communicate via the Internet. The information processing apparatus 20 includes a processor 21, a storage unit 22, a communication unit 23, and an input/output unit 24.

The processor 21 is a program-controlled device such as a central processing unit (CPU), for example, that operates according to programs installed in the information processing apparatus 20. The processor 21 has a function to execute the programs and generate moving images as the result of the execution of the programs.

The storage unit 22 is a storage device such as a read only memory (ROM) or a random access memory (RAM) or a hard disk drive, for example. The storage unit 22 stores the programs to be run by the processor 21, for example.

The communication unit 23 is a communication interface for wired communication or wireless communication, for example.

The input/output unit 24 is an input/output port such as a High-Definition Multimedia Interface (HDMI (registered trademark)) port or a universal serial bus (USB) port, for example.

The manipulating device 10 is capable of performing wired communication or wireless communication with the communication unit 23 of the information processing apparatus 20.

The display device 40 is preferably a liquid crystal display or the like, for example. Alternatively, the display device 40 may be a head-mounted display that the user can wear on his/her head.

As illustrated in FIG. 3, the information processing apparatus 20 implements an acquiring section 31, a calculating section 32, a display controlling section 33, and a pulling controller 34. The acquiring section 31 is implemented mainly by the processor 21 and the communication unit 23. The calculating section 32, the display controlling section 33, and the pulling controller 34 are mainly implemented by the processor 21. These functions are fulfilled by the computer as it executes the programs according to the present embodiment. The programs may be stored in a computer-readable information storage medium.

The acquiring section 31 acquires the positional coordinates of a plurality of grid points included in the manipulating device 10. According to the present embodiment, the positional coordinates of the plurality of grid points correspond respectively to the positional coordinates of the plurality of node mechanisms ND. Note that the positional coordinates of the plurality of node mechanisms ND are acquired on the basis of information detected by the various sensors included in the manipulating device 10.

The calculating section 32 calculates the positional coordinates of a plurality of control points associated in advance with the grid points, on the basis of the positional coordinates of the grid points at the plurality of node mechanisms ND. Note that the plurality of control points are preferably associated in advance with respective portions of a display object.

The display controlling section 33 determines respective display modes of a plurality of elements included in the display object, on the basis of the positional coordinates of the plurality of grid points that are associated in advance with the plurality of elements. Further, the display controlling section 33 displays the display object on the display device 40 on the basis of the positional coordinates of the plurality of control points that correspond respectively to the positional coordinates of the plurality of grid points.

Note that the pulling controller 34 will be described later.

### [Configuration of Manipulating Device]

Next, a configuration of the manipulating device 10 according to the present embodiment will be described below basically with reference to FIG. 2. FIG. 2 illustrates the manipulating device 10 as laid in a basic posture. In the present embodiment, the “basic posture” of the manipulating device 10 refers to a posture in which the plurality of node mechanisms ND are all in the same position in the upward and downward directions and are spaced at equal intervals in the forward and rearward directions and the leftward and rightward directions.

The manipulating device 10 has the plurality of node mechanisms ND and the plurality of link shafts SF.

The node mechanisms ND hold the ends of the link shafts SF while making the link shafts SF variable in posture. Each node mechanism ND holds ends of at least two or more link shafts SF. Further, opposite ends of all the link shafts SF are held by respective ones of the node mechanisms ND. Such a configuration makes the manipulating device 10 shaped as a grid in its entirety.

FIG. 2 illustrates an example in which five node mechanisms ND are arrayed in each of the forward and rearward directions and the leftward and rightward directions. In other words, FIG. 2 illustrates an example in which the manipulating device 10 has 25 node mechanisms ND. With such a layout, the manipulating device 10 has an essentially rectangular contour.

Note that, in FIG. 2, the node mechanisms ND and the link shafts SF are illustrated as exposed. However, when the manipulating device 10 is actually used by the user, it may be covered in its entirety with a cover of cloth, for example. In this case, the cover is preferably of a size and a material that can be deformed or expanded and contracted depending on changes in the posture of the manipulating device 10.

In FIG. 2, the node mechanism ND that is located at the front end and left end of the grid-shaped manipulating device 10 is denoted by reference signs “ND11.” Further, those node mechanisms ND that are progressively spaced rearwardly or rightwardly from the node mechanism ND11 are denoted by reference signs including progressively incremental numbers. That is, for example, the node mechanism ND that is positioned rearwardly adjacent to the node mechanism ND11 is denoted by “ND21” whereas the node mechanism ND that is positioned rightwardly adjacent to the node mechanism ND11 is denoted by “ND12.” However, in the present specification, in a case where a node mechanism does not need to be positionally distinguished from the other node mechanisms, it is simply referred to as the “node mechanism ND.”

A link shaft SF has its opposite ends held by respective node mechanisms ND and interconnects adjacent ones of the plurality of node mechanisms ND. Specifically, a link shaft SF interconnects node mechanisms ND that are adjacent to each other in the leftward and rightward directions, and a link shaft SF also interconnects node mechanisms ND that are adjacent to each other in the forward and rearward directions.

As illustrated in FIG. 2, of the plurality of link shafts SF, a shaft that extends in the leftward and rightward directions and interconnects node mechanisms ND that are adjacent to each other in the leftward and rightward directions is denoted by a reference sign “SF1.” Moreover, of the plurality of link shafts SF, a shaft that extends in the forward and rearward directions and interconnects node mechanisms ND that are adjacent to each other in the forward and rearward directions is denoted by a reference sign “SF2.” However, in the present specification, in a case where a link shaft does not need to be positionally distinguished from the other link shafts, it is simply referred to as the “link shaft SF.”

Note that, in FIG. 2, two link shafts SF are held by each of the node mechanisms ND11, ND15, ND51, and ND55 that are disposed at the respective corners of the grid-shaped manipulating device 10. Further, three link shafts SF are held by each of the node mechanisms ND12 through ND14, for example, that are disposed at the ends other than the corners. Moreover, four link shafts SF are held by the node mechanism ND22 and other node mechanisms ND that are disposed at positions other than the corners and ends. In such a manner, although the number of link shafts SF held by each of the node mechanisms ND varies depending on its position in the manipulating device 10, at least two or more link shafts are preferably held by one node mechanism ND.

### [Node Mechanism]

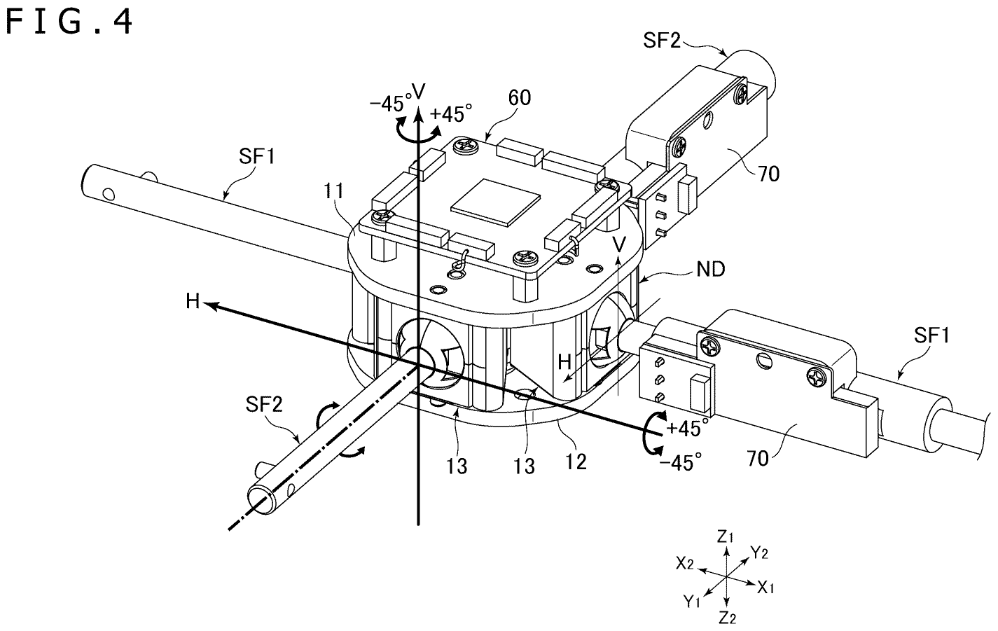

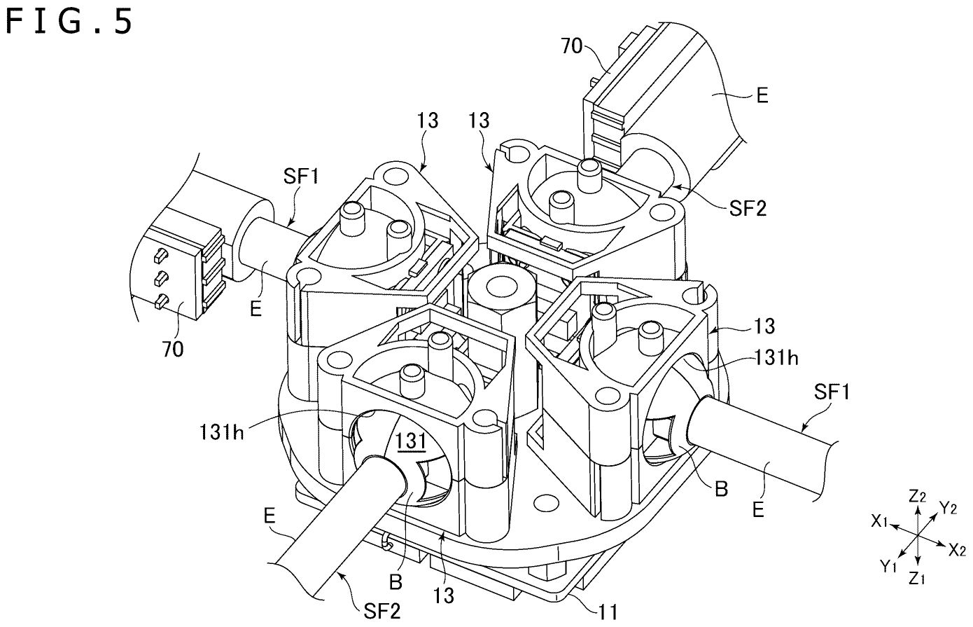

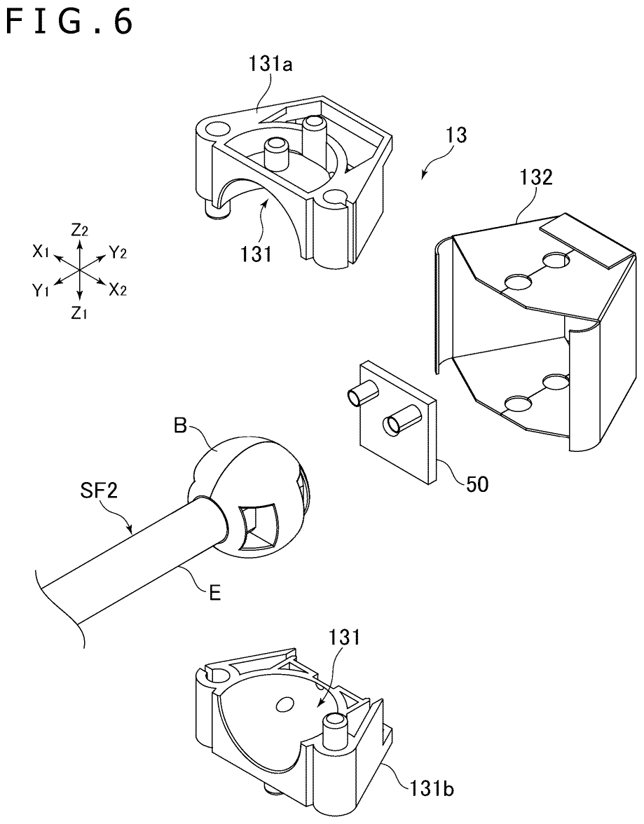

Next, details of a configuration of the node mechanisms ND will be described below with reference to FIGS. 4 through 6. FIG. 4 is a perspective view illustrating a single node mechanism and four link shafts held by the node mechanism. FIG. 5 is a perspective view illustrating the node mechanism with an outer covering removed therefrom. FIG. 6 is an exploded perspective view illustrating the node mechanism with a link shaft removed therefrom. FIGS. 4 and 5 illustrate a node mechanism ND to which there are attached four link shafts SF extending respectively in the forward, rearward, leftward, and rightward directions. Note that, in FIG. 5, the node mechanism illustrated in FIG. 4 is depicted as inverted in the upward and downward directions with at least a lower plate 12 and attachments 132 removed.

The node mechanism ND has an upper plate 11, a lower plate 12, and holders 13 that are sandwiched between the upper plate 11 and the lower plate 12 and that hold the ends of link shafts SF. The holders 13 are fixed to the upper plate 11 and the lower plate 12.

As illustrated in FIGS. 4 and 5, four holders 13 are included in one node mechanism ND in order to make the node mechanism ND connectable to the node mechanisms ND that are disposed adjacent thereto in the leftward and rightward directions and in the forward and rearward directions through the respective link shafts SF.

According to the present embodiment, as illustrated in FIG. 5, each of the holders 13 has a receptacle 131 that houses therein a spherical member B at the end of a link shaft SF to be described later and that has an inner wall shaped complementarily to the spherical member B. Further, the holder 13 has an opening 131h through which the receptacle 131 is open and that is smaller in diameter than the spherical member B.

Moreover, as illustrated in FIG. 4, one of the holders 13 holds the link shaft SF2 extending forwardly from the node mechanism ND, in a manner to allow the link shaft SF2 to vary angularly through ±45° about an X-axis and through ±45° about a Z-axis around the holder 13. The link shaft SF2 extending rearwardly from the node mechanism ND, the link shaft SF1 extending leftwardly therefrom, and the link shaft SF1 extending rightwardly therefrom are also held by the holder 13 in a similar manner to vary angularly.

As illustrated in FIG. 6, the holder 13 includes a first member 131a and a second member 131b that form the receptacle 131 and the attachment 132 to which the first member 131a and the second member 131b are attached.

Moreover, as illustrated in FIG. 6, a three-dimensional magnetic sensor 50 is included in each of the holders 13 as first detecting means for detecting a direction in which the link shaft SF extends from the node mechanism ND. Since four holders 13 are included in one node mechanism ND, one node mechanism ND includes four three-dimensional magnetic sensors 50. Note that the direction in which a link shaft SF extends from the node mechanism ND is stated otherwise as the angle through which the link shaft SF is tilted with respect to the node mechanism ND.

Each of the three-dimensional magnetic sensors 50 is preferably provided in facing relation to a magnet M disposed in the spherical member B of a link shaft SF to be described later for detecting a change in the magnetic field generated by the magnet M. Note that, according to the present embodiment, a three-dimensional magnetic sensor 50 capable of detecting magnetic signals in X-axis, Y-axis, and Z-axis directions is described by way of example as the first detecting means. However, the present invention is not limited to such a three-dimensional magnetic sensor. Magnetic sensors capable of detecting respective magnetic signals in the axis directions may instead be provided. Further, the first detecting means is not limited to magnetic sensors, and is only required to be sensors having a function to detect the direction in which the link shaft SF extends from the node mechanism ND.

Here, inasmuch as a plurality of link shafts SF are held by one node mechanism ND, a plurality of magnets M are disposed adjacent to each other. Therefore, those magnets M may magnetically affect each other, possibly making the three-dimensional magnetic sensors 50 unable to appropriately detect changes in the magnetic field. In view of this, according to the present embodiment, each holder 13 includes a magnetism minimizing wall partly therein. Specifically, each of the attachments 132 includes a magnetism minimizing wall including an iron plate that reduces the magnetic effect of magnets M. The magnetism minimizing wall is effective to prevent the three-dimensional magnetic sensor 50 from being magnetically affected by the other magnets M than the magnet disposed in facing relation to the three-dimensional magnetic sensor 50. As a result, the three-dimensional magnetic sensor 50 is able to accurately detect the direction in which the link shaft SF extends from the node mechanism ND that includes the three-dimensional magnetic sensor 50. Note that the magnetism minimizing wall may include a material of high magnetic permeability such as permalloy mainly including iron and nickel, for example.

Further, as illustrated in FIG. 4, an IMU 60 is mounted as second detecting means for detecting the posture of the node mechanism ND on the upper plate 11. The IMU 60 includes a gyrosensor and an acceleration sensor and detects the angular velocity and acceleration of the node mechanism ND. Note that, according to the present embodiment, the IMU is described by way of example as the second detecting means. However, the present invention is not limited to such an IMU. The second detecting means is instead only required to be a sensor having a function to detect the posture of the node mechanism ND.

Note that, although not illustrated, a microprocessor is preferably mounted on the lower plate 12. The microprocessor preferably calculates various items of information including the tilt angles of the link shafts SF and the lengths of the link shafts SF, for example, on the basis of output values from the various sensors. As the microprocessors are mounted in the respective node mechanisms ND in such a manner, real-time sensing can be guaranteed.

### [Link Shaft]

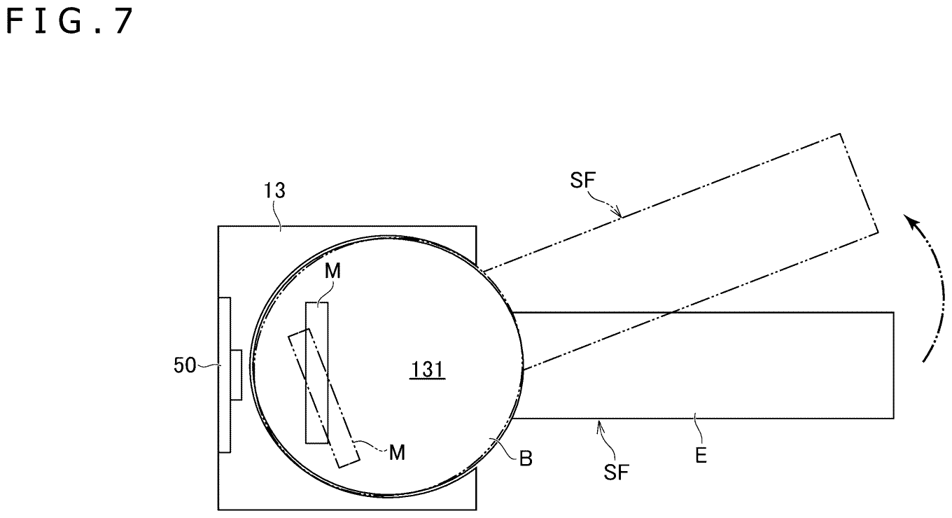

Next, details of a configuration of the link shafts SF will be described below with reference to FIGS. 4 through 7. FIG. 7 is a cross-sectional view illustrating a manner in which a magnet disposed in facing relation to a three-dimensional magnetic sensor is displaced.

Each of the link shafts SF has an elongate portion E extending in the leftward and rightward directions or the forward and rearward directions and the spherical member B at an end of the elongate portion E. According to the present embodiment, the elongate portion E is configured to be extendible and contractible. The elongate portion E is preferably made extendible and contractible by two members that are slidable against each other included therein. Elongate portions E that extend in the leftward and rightward directions are extendible and contractible in the leftward and rightward directions, whereas elongate portions E that extend in the forward and rearward directions are extendible and contractible in the forward and rearward directions. Each of the elongate portions E preferably has a maximum length that is approximately 1.4 times its minimum length.

Further, a position sensor 70 as third detecting means for detecting displacement of the elongate portion E is mounted on each elongate portion E. The position sensor is a resistance-type position sensor, for example, and preferably includes a variable resistor that converts a mechanical positional change into an analog electric signal. Displacement of the elongate portion E detected by the position sensor 70 is preferably output to the information processing apparatus 20 as information with respect to the distance between the two node mechanisms ND that hold the respective opposite ends of the link shaft SF that has the elongate portion E.

Moreover, as illustrated in FIG. 7, the magnet M is embedded in the spherical member B. The magnet M is preferably a permanent magnet. The magnet M is preferably provided in facing relation to the three-dimensional magnetic sensor 50 provided in the node mechanism ND. The magnet M has its orientation changed upon a change in the direction in which the link shaft SF extends from the node mechanism ND. When the orientation of the magnet M is changed, the magnetic field detected by the three-dimensional magnetic sensor 50 is changed. The change in the magnetic field detected by the three-dimensional magnetic sensor 50 is preferably output to the information processing apparatus 20 as information with respect to the direction in which the link shaft SF extends from the node mechanism ND.

Note that solid lines in FIG. 7 represent the link shaft SF at the time when the manipulating device 10 is laid in the basic posture, whereas broken lines in FIG. 7 represent the link shaft SF that is tilted with respect to the node mechanism ND. In the solid-line state illustrated in FIG. 7 and the broken-line state illustrated in FIG. 7, the magnet M has different postures with respect to the three-dimensional magnetic sensor 50, and hence, the three-dimensional magnetic sensor 50 detects different magnetic fields.

### [Transmission Paths]

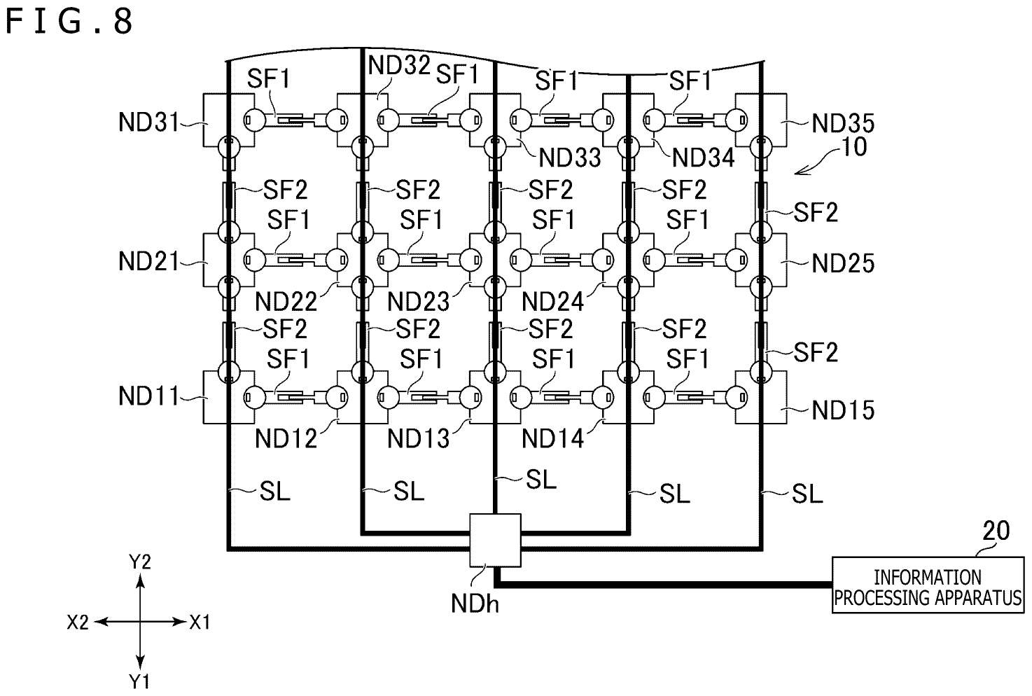

Next, transmission paths of the display control system 100 according to the present embodiment will be described below with reference to FIG. 8. FIG. 8 is a view schematically illustrating a wiring arrangement of the display control system according to the present embodiment. Note that, in FIG. 8, some of the node mechanisms ND and the link shafts SF are omitted from illustration, though their layouts remain the same as those illustrated in FIG. 2.

As described above, the three-dimensional magnetic sensors 50 and the IMUs 60 are mounted respectively in the plurality of node mechanisms ND. Further, the position sensors 70 are mounted respectively on the plurality of link shafts SF. Signals detected by these sensors are output to the information processing apparatus 20. If signal lines were individually connected to the plurality of node mechanisms ND, the wiring would be complicated.

In view of this, according to the present embodiment, there is employed an arrangement in which five node mechanisms ND arrayed in the forward and rearward directions output signals via a common transmission path to the information processing apparatus 20. Specifically, as illustrated in FIG. 8, a common signal line SL is connected to the five node mechanisms ND arrayed in the forward and rearward directions. In other words, according to the present embodiment, there are employed five signal lines SL arrayed in the leftward and rightward directions.

According to the present embodiment, further, a host node mechanism NDh is provided as an information collector for collecting signals transmitted through the five signal lines SL. The signals from the 25 node mechanisms ND can thus be collected by the single host node mechanism NDh and output via the host node mechanism NDh to the communication unit 23 of the information processing apparatus 20 (see FIG. 1). Note that, although the term “host node mechanism NDh” is used herein for the sake of convenience, the host node mechanism NDh is different in configuration from the node mechanisms ND. Specifically, the host node mechanism NDh does not have various sensors and the like.

Further, it is preferred that electric power lines also be of the same wiring arrangement as that of the signal lines SL illustrated in FIG. 8. In other words, the five node mechanisms ND arrayed in the forward and rearward directions are preferably supplied with electric power via a common electric power line.

Note that, here, the manipulating device 10 has been described by way of example as including the signal lines SL and the electric power lines. However, the present invention is not limited to such details, and the node mechanisms ND may transmit signals to the information processing apparatus 20 by way of wireless communication. According to the alternative, each of the node mechanisms ND preferably incorporates a wireless communication circuit. The wireless communication technology thus used requires no wiring, making it possible to allow the manipulating device 10 to change more flexibly in posture.

### [Acquisition of Positional Coordinates of Node Mechanisms]

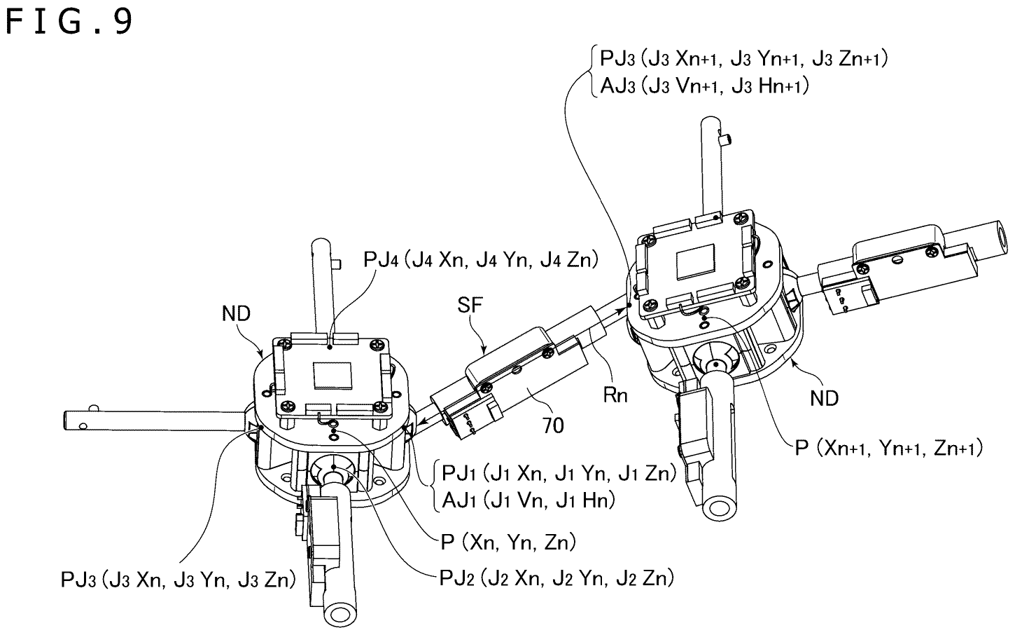

Next, acquisition of positional coordinates of the node mechanisms ND will be described below with reference to FIG. 9. FIG. 9 is a view illustrating positional coordinates of various portions of node mechanisms. Here, the plurality of node mechanisms ND are assigned respective node numbers. Specifically, as illustrated in FIG. 2, according to the example in which there are 25 node mechanisms ND, each of the node mechanisms ND is assigned either one of 1 through 25. FIG. 9 illustrates a node mechanism ND having a node number n and a node mechanism ND having a node number n+1.

FIG. 9 illustrates a manner in which the link shaft SF interconnecting the node mechanisms DN having the node numbers n and n+1 is tilted and the node mechanism DN having the node number n+1 is tilted in its own posture. Acquisition of positional coordinates of the node mechanism DN having the node number n+1 in this state will be described below.

It is assumed that the central position of the node mechanism ND having the node number n has coordinates Pₙ (Xₙ, Yₙ, Zₙ) and that the central position of the node mechanism ND having the node number n+1 has coordinates Pₙ₊₁ (Xₙ₊₁, Yₙ₊₁, Zₙ₊₁). Further, according to the present embodiment, the coordinates of the central position of a node mechanism ND represent the positional coordinates of the node mechanism ND.

Moreover, the coordinates of the held positions where the four link shafts SF are held by the node mechanism ND having the node number n are represented by PJₘ (JₘXₙ, JₘYₙ, JₘZₙ) where m represents shaft numbers 1 through 4. According to the present embodiment, each of the held positions is located at the center of the spherical member B of one of the link shafts SF. As illustrated in FIG. 9, the first held position PJ₁ is located across the central position of the node mechanism ND from the third held position PJ₃. Moreover, the second held position PJ₂ is located across the central position of the node mechanism ND from the fourth held position PJ₄.

Similarly, the coordinates of the held positions where the four link shafts SF are held by the node mechanism ND having the node number n+1 are represented by PJₘ (JₘXₙ₊₁, JₘYₙ₊₁, JₘZₙ₊₁) where m represents shaft numbers 1 through 4.

Moreover, the angles of a link shaft SF held by the node mechanism ND having the node number n around a V-axis (yaw axis) and an H-axis (pitch axis) illustrated in FIG. 4 are denoted by AJₘ (JₘVₙ, JₘHₙ).

Further, the length between the first held position PJ₁ and the third held position PJ₃ in each node mechanism ND is denoted by W. Moreover, the length of a link shaft SF from the first held position PJ₁ where one end of the link shaft SF is held by the node mechanism ND having the node number n to the third held position PJ₃ where the other end of the link shaft SF is held by the node mechanism ND having the node number n+1 is denoted by Rn. The length W refers to a preset fixed length whereas the length Rn refers to a length variable depending on the length of the link shaft SF that is extendible and contractible.

For example, in a case where the coordinates of the central position of the node mechanism ND having the node number n are represented by (0, 0, 0), the coordinates (J₁Xₙ, J₁Yₙ, J₁Zₙ) of the first held position PJ₁ in the node mechanism ND are represented by (W/2, 0, 0). Similarly, the coordinates (J₂Xₙ, J₂Yₙ, J₂Zₙ) of the second held position PJ₂ are represented by (0, −W/2, 0), the coordinates (J₃Xₙ, J₃Yₙ, J₃Zₙ) of the third held position PJ₃ are represented by (−W/2, 0, 0), and the coordinates (J₄Xₙ, J₄Yₙ, J₄Zₙ) of the fourth held position PJ₄ are represented by (0, w/2, 0).

Moreover, the coordinates (J₃Xₙ₊₁, J₃Yₙ₊₁, J₃Zₙ₊₁) of the third held position PJ₃ in the node mechanism ND having the node number n+1 are represented by way of polar coordinate transformation on the basis of the first held position PJ₁ in the node mechanism ND having the node number n and the angles AJ₁ about the V-axis and the H-axis of the link shaft SF held at the first held position PJ₁, as follows:

$${J}_{3} {X}_{n + 1} = {J}_{1} {X}_{n} + {R}_{n} * sin ( 90 ° - {J}_{1} {V}_{n} ) ⋆ cos ( {J}_{1} {H}_{n} ) \\ {J}_{3} {Y}_{n + 1} = {J}_{1} {Y}_{n} + {R}_{n} * sin ( 90 ° - {J}_{1} {V}_{n} ) ⋆ sin ( {J}_{1} {H}_{n} ) \\ {J}_{3} {Z}_{n + 1} = {J}_{1} {Z}_{n} + {R}_{n} * cos ( 90 ° - {J}_{1} {V}_{n} )$$

Further, the tilt of the posture of the node mechanism ND having the node number n+1, i.e., the angles about the V-axis and the H-axis, is represented by (Vₙ₊₁, Hₙ₊₁). In this case, the coordinates P (Xₙ₊₁, Yₙ₊₁, Zₙ₊₁) of the central position of the node mechanism ND having the node number n+1 are represented on the basis of the coordinates (J₃Xₙ₊₁, J₃Yₙ₊₁, J₃Zₙ₊₁) of the third held position PJ₃ in the node mechanism ND having the node number n+1, as follows:

$${X}_{n + 1} = {J}_{3} {X}_{n + 1} + W / 2 * sin ( 90 ° - {V}_{n + 1} ) * cos ( {H}_{n + 1} ) \\ {Y}_{n + 1} = {J}_{3} {Y}_{n + 1} + W / 2 * sin ( 90 ° - {V}_{n + 1} ) * sin ( {H}_{n + 1} ) \\ {Z}_{n + 1} = {J}_{3} {X}_{n + 1} + W / 2 * cos ( 90 ° - {V}_{n + 1} )$$

As described above, the positional coordinates of the node mechanism ND having the node number n+1 can be calculated on the basis of the tilt of the posture of the node mechanism ND having the node number n+1, the tilt angle of the link shaft SF with respect to the node mechanism ND having the node number n, and the length of the link shaft SF in addition to the positional coordinates of the node mechanism ND having the node number n. The positional coordinates of all the node mechanisms ND can be acquired by performing such calculations depending on the number of the node mechanisms ND. Note that the tilt angle of the link shaft SF is detected on the basis of the output value from the three-dimensional magnetic sensor 50, the length of the link shaft SF is detected on the basis of the output value from the position sensor 70, and the tilt of the posture of the node mechanism ND is detected on the basis of the output value from the IMU 60.

Note that calculating the positional coordinates of all the node mechanisms ND in a similar manner is not indispensable. Estimated values that are estimated from the positional coordinates of peripheral node mechanisms ND, for example, may be used for such calculations.

### [Pulling Mechanism 80]

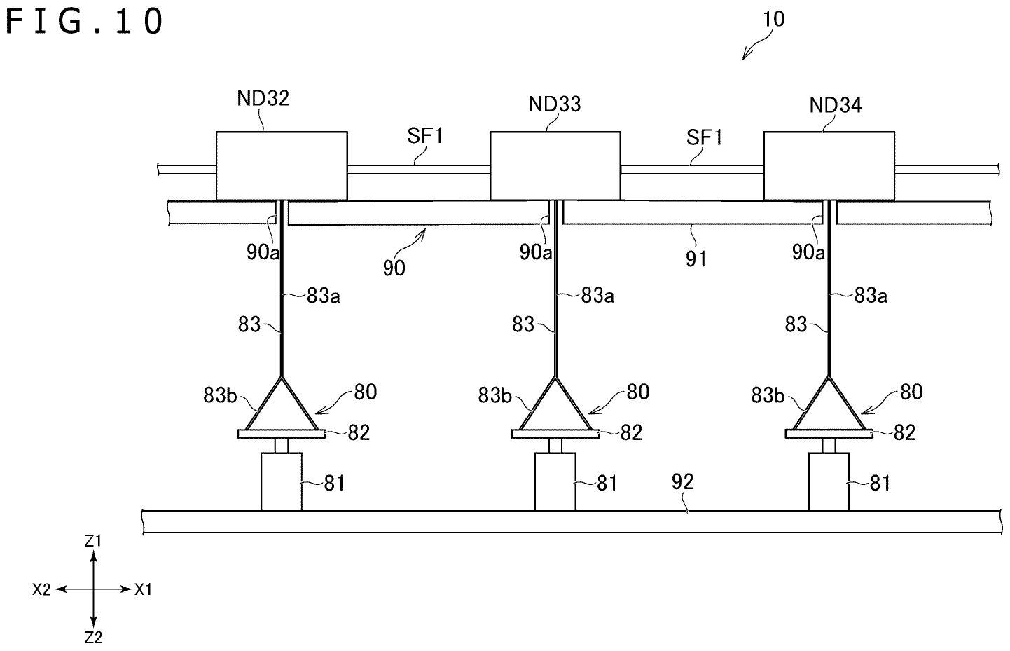

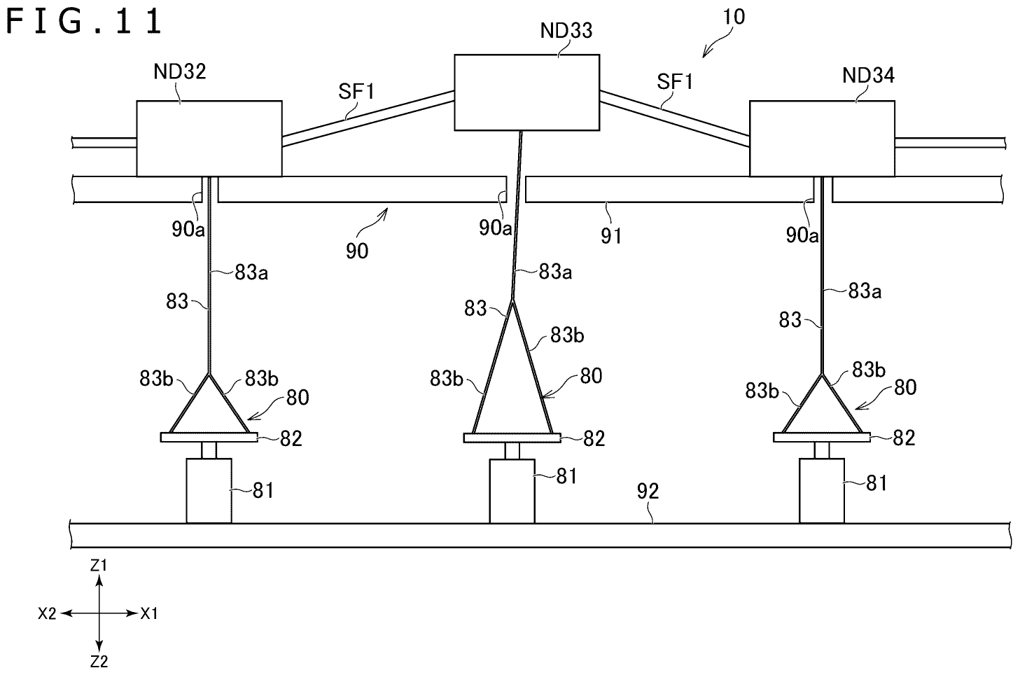

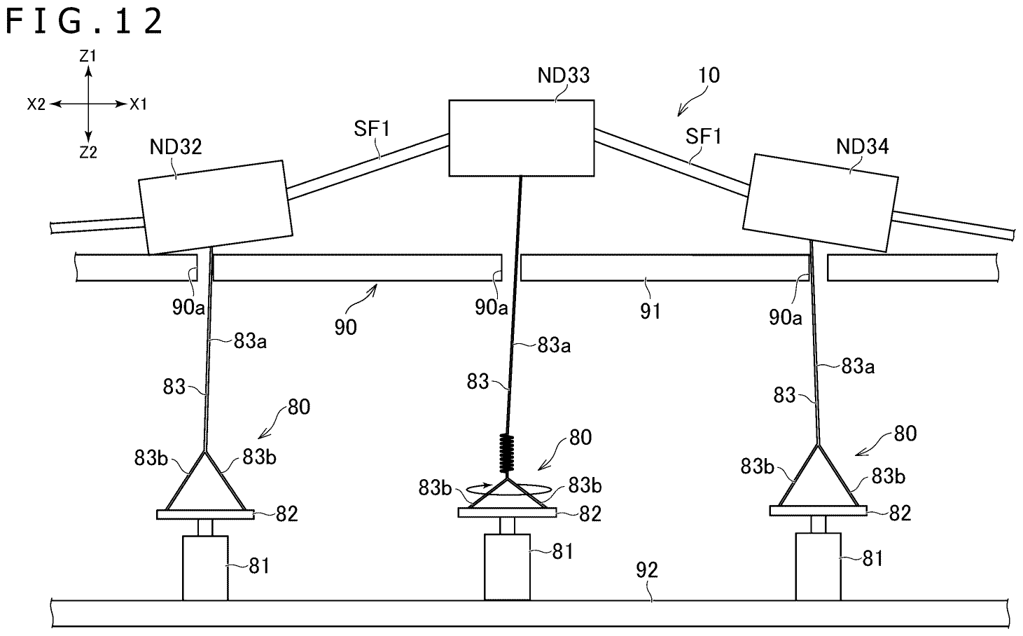

Next, a pulling mechanism 80 for generating a pseudo-weight will be described below. First, a configuration of the pulling mechanism 80 according to the present embodiment will be described below mainly with reference to FIG. 2 and FIGS. 10 through 12. FIG. 10 is a view schematically illustrating a pulling mechanism and members disposed in its periphery according to the present embodiment. FIG. 11 is a view illustrating a manner in which a node mechanism illustrated in FIG. 10 is displaced upwardly. FIG. 12 is a view illustrating a manner in which an electric motor of the pulling mechanism is driven by further displacing the node mechanism illustrated in FIG. 11 upwardly.

As illustrated in FIG. 10 and other figures, the manipulating device 10 has a plurality of pulling mechanisms 80 associated respectively with the plurality of node mechanisms ND. Further, as illustrated in FIG. 2, the manipulating device 10 has a rest base 90 on which the plurality of node mechanisms ND are placed.

Each of the pulling mechanisms 80 has an electric motor 81 as a driver, a rotor 82 rotatable with a rotational shaft of the electric motor 81, and a connector 83 that interconnects the rotor 82 and the node mechanism ND.

The electric motor 81 is, for example, preferably a stepping motor that intermittently rotates through certain angles under control of the pulling controller 34. The rotor 82 is rotatable about an axis coaxial with the rotational shaft of the electric motor 81.

The rest base 90 is preferably of a box shape that has a cavity defined therein. Specifically, as illustrated in FIGS. 2 and 10, the rest base 90 is preferably of a shape with the cavity defined therein that is surrounded by an upper plate 91, a lower plate 92, and side walls 93.

It is preferred that the pulling mechanisms 80 be housed in the rest base 90 and have respective portions fixed to the lower plate 92. FIG. 10 and other figures illustrate an example in which the electric motors 81 have respective portions, other than the rotational shafts, fixed to the lower plate 92.

The pulling mechanisms 80 are preferably provided directly below the node mechanisms ND that are in a reference position. Here, the reference position refers to the position of each node mechanism ND where the manipulating device 10 is in the basic posture. FIG. 10 illustrates node mechanisms ND32, ND33, and ND34 in the reference position and the pulling mechanisms 80 associated respectively therewith.

The upper plate 91 of the rest base 90 has openings 90a defined therein through which the connectors 83 are inserted. It is preferred that the openings 90a have widths large enough to accommodate the connectors 83 inserted therethrough and be smaller than the contour of the node mechanisms ND. The openings 90a are preferably disposed in positions covered with the node mechanisms ND that are in the reference position.

As FIG. 10 and other figures, each of the connectors 83 has an upper end connected to a lower portion of the node mechanism ND and a lower end connected to the rotor 82. The connector 83 includes a wire 83a connected to the lower portion of the node mechanism ND and a rubber string 83b connected to the lower end of the wire 83a and connected to the rotor 82 at a plurality of locations thereon. FIG. 10 and other figures illustrate an example in which the rubber string 83b is of a bifurcated shape.

When the bifurcated rubber string 83b is twisted upon rotation of the rotor 82, it produces a force tending to pull the lower end of the wire 83a downwardly. Note that, when the rotor 82 is rotated in a direction opposite a direction in which the rubber string 83b has been twisted, the rubber string 83b is released from the twisted state, reducing the force tending to pull the lower end of the wire 83a downwardly.

The electric motors 81 are controlled by the pulling controller 34. For example, in a case where a node mechanism ND is in a position equal to or higher than a predetermined height in the Z-axis direction, the pulling controller 34 preferably drives the electric motor 81 of the pulling mechanism 80 associated with the node mechanism ND. Specifically, first, the acquiring section 31 acquires positional coordinates of the node mechanism ND in the Z-axis direction. Then, the pulling controller 34 preferably drives the electric motor 81 in a case where the positional coordinates of the node mechanism ND in the Z-axis direction become equal to or larger than predetermined values.

FIG. 11 illustrates a manner in which the node mechanism ND33 has been pinched and picked to a height smaller than the predetermined height in the Z-axis direction. In this state, the electric motor 81 is not driven. In FIG. 11, the rubber string 83b is illustrated as stretched because the node mechanism ND33 has been pinched and picked. The stretched rubber string 83b makes the user who has pinched and picked the node mechanism ND33 feel a pseudo-weight depending on the elastic force imposed by the rubber string 83b.

FIG. 12 illustrates a manner in which the node mechanism ND33 has been pinched and picked to a height equal to or higher than the predetermined height in the Z-axis direction. In this state, the electric motor 81 is driven, twisting the rubber string 83b to thereby pull the lower end of the wire 83a downwardly. Therefore, the node mechanism ND33 is pulled in a direction to return to the reference position. As a result, the user who has pinched and picked the node mechanism ND33 feels a pseudo-weight depending on the force tending to pull the lower end of the wire 83a.

The pulling mechanism 80 may be configured to make the force tending to pull the node mechanism ND variable depending on the displacement from the reference position. For example, the pulling controller 34 preferably drives the electric motor 81 to pull the node mechanism ND with a larger force as the amount of displacement from the reference position is larger. Further, there may be established a plurality of threshold values for the amount of displacement across which pulling forces switch one from another.

Moreover, it is preferred that the pulling controller 34 drive the electric motor 81 to increase the force tending to pull the node mechanism ND as the amount of displacement from the reference position increases, until the amount of displacement reaches a predetermined threshold value, and that the pulling controller 34 stop driving the electric motor 81 in a case where the amount of displacement from the reference position becomes equal to or larger than the predetermined threshold value. This allows the user who is manipulating the manipulating device 10 to have a feeling as if something displaced to a large extent had broken off. Specifically, It is preferred that, when a certain node mechanism ND is pinched and picked, the display device 40 display a manner in which an object joined to a string is lifted upwardly, and that driving of the electric motor 81 be stopped at the time when the string is displayed as tearing off. The user is thus able to have a feeling as if the string had torn off.

Note that, as illustrated in FIG. 12, when the node mechanism ND33 is pinched and picked upwardly to a large extent, the node mechanisms ND32 and ND34, for example, in the periphery of the node mechanism ND33 are also displaced upwardly. It is preferred that, with respect to the node mechanisms ND32 and ND34, for example, similarly, pulling forces to return to the reference positions be generated by the pulling mechanisms 80 associated with the node mechanisms ND32 and ND34, for example.

In FIGS. 11 and 12, the pulling mechanism 80 is illustrated by way of example as being driven in a case where the node mechanism ND is displaced in the Z-axis direction. The present invention is not limited to such details, and it is sufficient if a pulling force is generated in order to return at least the node mechanism ND to the reference position.

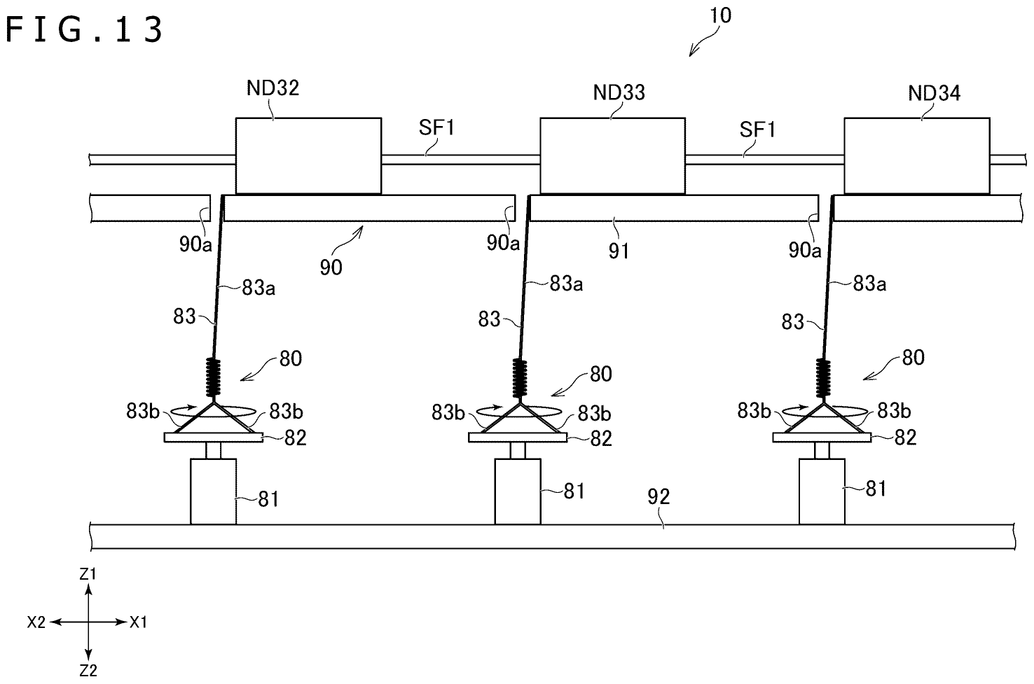

FIG. 13 is a view illustrating a manner in which node mechanisms are displaced in the X-axis direction according to the present embodiment. As illustrated in FIG. 13, the pulling mechanisms 80 may be driven in a case where the node mechanisms ND are displaced in the X-axis direction. This allows the user to feel not only a weight in the gravitational direction but also weights in the forward, rearward, leftward, and rightward directions. Such a mode of control is preferably performed in expressing that a magnetic force is produced in a manner to match the display on the display device 40 or expressing the viscosity of an object.

Note that each of the connectors 83 is only required to have at least a portion including a material that is elastically extendible and contractible. Further, each of the wires 83a is not necessarily metal, and may be thread, for example. Moreover, each of the connectors 83 may not be fixed to the node mechanism ND, and may be detachable from the node mechanism ND. In other words, the plurality of node mechanisms ND may be separated from the rest base 90 and used independently of each other.

Note that the pulling mechanisms 80 may be driven to return the node mechanisms ND to their reference positions regardless of the amount of displacement of the node mechanisms ND from their reference positions. Therefore, even in a case where the node mechanisms ND are placed randomly on the rest base 90, the pulling mechanisms 80 is driven to allow the node mechanisms ND to return to their reference positions. In other words, the manipulating device 10 can be put back to the state illustrated in FIG. 2.

### First Modification

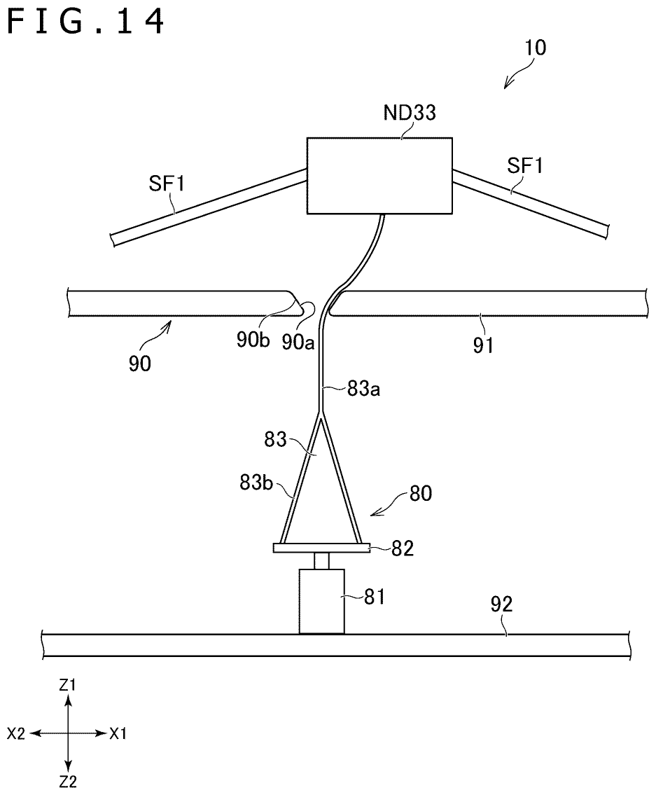

FIG. 14 is a view schematically illustrating a rest base and members disposed in its periphery according to a first modification of the present embodiment. As illustrated in FIG. 14, the opening 90a defined in the rest base 90 may include a tapered portion 90b. The tapered portion 90b is preferably shaped such that the diameter of the opening 90a is progressively larger in an upward direction. Further, the tapered portion 90b preferably has round upper and lower ends. Such a configuration is effective to reduce the load on the connector 83 caused by its contact with the edges of the opening 90a and to increase the range in which the node mechanism ND is movable in the X-axis and Y-axis directions.

Note that the opening 90a in FIG. 14 is illustrated by way of example only. The opening 90a may be free of the tapered portion 90b, and may be of such a shape that the opening 90a has an inner wall whose upper and lower ends are round. The alternative shape of the opening 90a is effective to reduce the load on the connector 83 caused by its contact with the edges of the opening 90a. Further, the round shape may be given to only either one of the upper and lower ends of the inner wall of the opening 90a.

### Second Modification

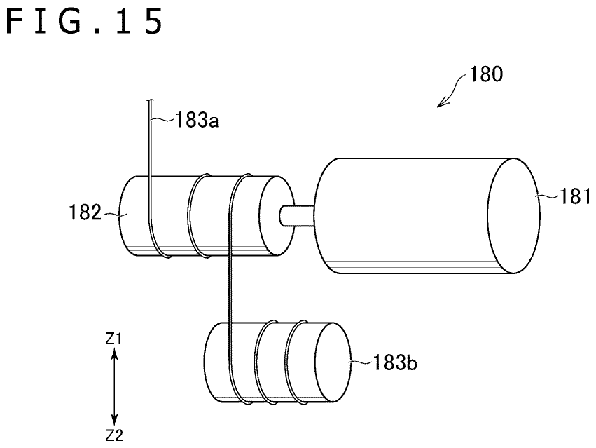

The pulling mechanisms are not limited to the configuration illustrated in FIG. 10 and other figures, and is only required to be of a configuration for producing forces tending to pull the node mechanisms ND back to predetermined reference positions on the rest base 90. FIG. 15 is a perspective view schematically illustrating a pulling mechanism according to a second modification of the present embodiment.

The pulling mechanism, denoted by 180, according to the second modification has a direct-current motor 181, a rotor 182, and a CONSTON spring. A plurality of pulling mechanisms 180 are preferably disposed respectively below a plurality of node mechanisms ND associated therewith.

The direct-current motor 181 is controlled by the pulling controller 34. The rotor 182 rotates upon rotation of a rotational shaft of the direct-current motor 181.

The CONSTON spring has a spring 183a as a connector and a take-up roll 183b for winding the spring 183a therearound. The spring 183a has an upper end connected to the node mechanism ND and a lower end portion that can be wound around and paid out from the take-up roll 183b. Further, as illustrated in FIG. 15, the spring 183a is wound around the rotor 182. The CONSTON spring refers to a spring that produces a constant returning force regardless of the length of the spring 183a that has been wound or paid out.

According to the second modification, when the rotational shaft of the direct-current motor 181 rotates, it rotates the rotor 182. When the rotor 182 is rotated, it produces a force for pulling the upper end of the spring 183a downwardly. The node mechanism ND is thus pulled to return to the predetermined reference position. As a result, the user who has pinched and picked the node mechanism ND feels a pseudo-weight depending on the force with which the spring 183a is wound around the rotor 182 that is rotated by energizing the direct-current motor 181. Further, when the direct-current motor 181 is de-energized, the user who has pinched and picked the node mechanism ND feels a pseudo-weight depending on the returning force of the spring 183a.

### Conclusions

As described above, according to the present embodiment, it is possible to make the user who moves the node mechanism ND feel a pseudo-weight. By causing the pulling mechanism 80 to produce a force for returning the node mechanism ND to the reference position, depending on an object and the like displayed on the display device 40, it is possible to make the user experience a feeling of presence through its perception. According to the present embodiment, furthermore, since the configuration capable of adjusting the force for pulling the node mechanism ND is employed, it is possible to make the user experience a better feeling of presence.

### Others

According to the present embodiment, there has been described an example in which n=5 and m=5 where n represents the number of arrays of node mechanisms ND in the forward and rearward directions and m represents the number of arrays of node mechanisms ND in the leftward and rightward directions. However, n and m are not limited to such numbers, and it is preferred that n and m be each an integer of at least 3 or more. Moreover, n and m may represent different numbers.

Further, the number of node mechanisms ND included in the manipulating device 10 may be variable. For example, of the node mechanisms ND illustrated in FIG. 2, the node mechanisms ND including the holders 13 that do not hold link shafts SF may hold link shafts SF, thereby making it possible to change n and m to 6 or more. To this end, the node mechanisms ND preferably share a common configuration regardless of the number of the node mechanisms ND that hold link shafts SF. Moreover, the common configuration of the node mechanisms ND is effective to reduce the manufacturing cost thereof. The link shafts SF also preferably share a common configuration regardless of their layout and orientation.

Further, the manipulating device 10 in an example according to the present embodiment includes a quadrangular grid shape including four node mechanisms ND adjacent to each other and four link shafts SF interconnecting them. The present invention is not limited to such details, and it is sufficient if a manipulating device includes a polygonal grid shape. For example, node mechanisms ND and link shafts SF may be arranged to provide a triangular grid shape or a pentagonal grid shape, for example.

Further, each rink shaft SF may be rotatable around a roll axis (indicated by a dot-and-dash line in FIG. 4) with the V-axis as a yaw axis and the H-axis as a pitch shaft as illustrated in FIG. 4. In other words, the node mechanisms ND may hold the link shafts SF such that the link shafts SF are rotatable about axes along the directions in which the link shafts SF extend. With such an arrangement, the manipulating device 10 can have a higher degree of freedom for posture.

According to the present embodiment, there has been described an example in which the manipulating device 10 includes various sensors for acquiring the positional coordinates of the node mechanisms ND. However, the present invention is not limited to such details. The positional coordinates of the node mechanisms ND may be acquired with use of a camera or the like that captures an image of the manipulating device 10 from outside thereof. In this case, it is preferred that the camera be able to acquire three-dimensional positional data.

As described above, the manipulating device 10 may have its shape varied by the weight of the node mechanisms ND. Specifically, for example, one of the node mechanism ND11 and the node mechanism ND12 illustrated in FIG. 2 preferably holds a link shaft SF1 such that the direction in which the link shaft SF1 held thereby extends is varied by the weight of the other of the node mechanism ND11 and the node mechanism ND12. Therefore, when the manipulating device 10 is placed on a surface having surface irregularities, for example, the manipulating device 10 preferably has its shape varied along the surface irregularities.

Moreover, the manipulating device 10 preferably does not have biasing means or the like for returning its shape to the original shape thereof. In other words, it is preferred that the manipulating device 10 be able to maintain its shape except in a case where the user manipulates the manipulating device 10 to change its shape.

For example, the manipulating device can also be configured as follows.

(1)

A manipulating device for outputting signals to a computer, depending on its posture changes caused by manipulations made by a user, the manipulating device including:
a plurality of link shafts;
a plurality of node mechanisms that cooperate with the plurality of link shafts in providing a grid shape, the plurality of node mechanisms holding ends of at least two or more of the link shafts of the plurality of link shafts such that the at least two or more of the link shafts are variable in posture;
a rest base on which the plurality of node mechanisms are placed; and a pulling mechanism for pulling each of the node mechanisms in a direction to return to a predetermined reference position on the rest base.
   (2)

The manipulating device according to (1),
in which the pulling mechanism is configured to make a force to pull the node mechanism variable depending on the amount of displacement.
   (3)

The manipulating device according to (1) or (2),
in which the pulling mechanism has a driver and a connector connected to the node mechanism for pulling the node mechanism in response to driving of the driver.
   (4)

The manipulating device according to (3),
in which the connector has at least a portion including a material that is elastically extendible and contractible.
   (5)

The manipulating device according to (3) or (4),
in which the driver is driven to increase a force to pull the node mechanism as the amount of displacement increases.
   (6)

The manipulating device according to any one of (3) through (5),
in which the driver is driven to pull the node mechanism in the direction to return to the predetermined reference position in a case where the amount of displacement is smaller than a predetermined threshold value, and stops being driven in a case where the amount of displacement is equal to or larger than the predetermined threshold value.
   (7)

The manipulating device according to any one of (3) through (6),
in which the driver is housed in the rest base.
   (8)

The manipulating device according to any one of (1) through (7),
in which the pulling mechanism includes a plurality of pulling mechanisms associated respectively with the plurality of node mechanisms.

1. A manipulating device for outputting signals to a computer, depending on its posture changes caused by manipulations made by a user, the manipulating device comprising:
a plurality of link shafts;
a plurality of node mechanisms that cooperate with the plurality of link shafts in providing a grid shape, the plurality of node mechanisms holding ends of at least two or more of the link shafts of the plurality of link shafts such that the at least two or more of the link shafts are variable in posture;
a rest base on which the plurality of node mechanisms are placed; and
a pulling mechanism for pulling each of the node mechanisms in a direction to return to a predetermined reference position on the rest base.

2. The manipulating device according to claim 1,
wherein the pulling mechanism is configured to make a force to pull the node mechanism variable depending on the amount of displacement.

3. The manipulating device according to claim 2,
wherein the pulling mechanism has a driver and a connector connected to the node mechanism for pulling the node mechanism in response to driving of the driver.

4. The manipulating device according to claim 3,
wherein the connector has at least a portion including a material that is elastically extendible and contractible.

5. The manipulating device according to claim 3,
wherein the driver is driven to increase a force to pull the node mechanism as the amount of displacement increases.

6. The manipulating device according to claim 3,
wherein the driver is driven to pull the node mechanism in the direction to return to the predetermined reference position in a case where the amount of displacement is smaller than a predetermined threshold value, and stops being driven in a case where the amount of displacement is equal to or larger than the predetermined threshold value.

7. The manipulating device according to claim 3,
wherein the driver is housed in the rest base.

8. The manipulating device according to claim 1,
wherein the pulling mechanism includes a plurality of pulling mechanisms associated respectively with the plurality of node mechanisms.
